(19) United States
(12) Patent Application Publication
(10) Pub. No.: US 2011/0057967 A1
(43) Pub. Date: Mar. 10, 2011

(54) IMAGE DISPLAY DEVICE

(75) Inventors: Takeshi Adachi, Saitama (JP); Masahiko Nagano, Kanagawa (JP); Kohji Nagano, Kanagawa (JP)

(73) Assignees: MITSUMI ELECTRIC CO., LTD., Tokyo (JP); ARTC CORPORATION, Saitama (JP)

(21) Appl. No.: 12/935,034

(22) PCT Filed: Mar. 4, 2009
(86) PCT No.: PCT/JP2009/054083

§ 371 Date: Nov. 26, 2010

(30) Foreign Application Priority Data
Apr. 1, 2008 (JP) 2008-094475
Jan. 14, 2009 (JP) 2009-006160

(51) Int. Cl. G09G 5/10

(52) U.S. Cl. 345/690; 345/76; 345/87

(57) ABSTRACT

An image display device displays an input video signal on a display panel. The image display device includes: a computation unit which computes the reciprocal of a luminance signal and/or a chrominance signal, acquired when a white signal in the order of 100% is input to display a white screen on the display panel and an image of the white screen is captured by an imaging device; a memory unit which stores the reciprocal computed by the computation unit as correction data; and a correction unit which corrects luminance irregularity and/or color irregularity on the display panel by multiplication of the input video signal and the correction data stored in the memory unit.

### TECHNICAL FIELD

The present disclosure relates to a flat-panel image display device which employs a liquid crystal display having a backlight, or an organic EL panel, an inorganic EL panel, etc. and relates to an image display device which is adapted to correct luminance irregularity and color irregularity due to variations in the backlight, the organic EL panel or the inorganic EL panel with ease and with low cost.

### BACKGROUND ART

Recently, many flat-panel image display devices employ a liquid crystal display. The mainstream liquid crystal display is arranged so that a transmission-type liquid crystal display panel including a color filter is illuminated by a backlight on the back of the display panel and a color image is displayed.

Conventionally, a CCFL (cold cathode fluorescent lamp) which employs a fluorescent lamp was used as the backlight. However, in consideration of the environmental problems, the use of mercury as contained in the CCFL has been restricted. As an alternative light source to the CCFL, a light emitting diode LED is currently in use. For example, refer to Patent Document 1 listed below.

Backlight devices using the light emitting diode may be classified according to the arrangement of the light source into two types: an underneath type and an edge type. The underneath type is a type of the backlight device in which the light source is arranged directly underneath the back surface of the liquid crystal panel. The edge type is a type of the backlight device in which a light guiding plate is arranged underneath the back surface of the liquid crystal panel and the light source is arranged at a side surface portion of the light guiding plate. The edge type is mainly used in a comparatively small liquid crystal panel, such as a display unit of a mobile phone or a notebook PC. Moreover, there are two kinds of the backlight devices using the light emitting diode as the light source: one kind using a white light emitting diode as the light source, and the other kind using a red light emitting diode, a green light emitting diode and a blue light emitting diode in order to obtain a white light by the mixture of respective light beams emitted by these light emitting diodes (the primary colors of light).

It is also proposed to use a surface light source employing an organic or inorganic EL (electro luminescence) plate as a light source of a backlight. However, this does not yet result in the adoption of the surface light source to televisions and other devices. For example, refer to Patent Document 2 listed below.

Generally, in a case of a backlight device using light emitting diodes, each light emitting diode is a semiconductor device which has a large variation in luminance or chromaticity. If light emitting diodes which are selected at random are used, luminance irregularity or color irregularity of the light emitting diodes may be detrimental to the image quality. To avoid the problem, the screening of light emitting diodes is needed. Patent Document 3 listed below discloses a backlight apparatus in which light emitting diode units having variations in luminance or chromaticity are arranged so as to reduce the luminance irregularity or the color irregularity of the light emitting diode units. In the backlight device of Patent Document 3, a plurality of light emitting diode units having different luminance or chromaticity characteristics are arranged in a two-dimensional matrix formation and these light emitting diode units are arrayed in a central row or a peripheral row of a color liquid crystal display panel depending on the luminance or chromaticity characteristics so as to reduce the luminance irregularity or the color irregularity.

A backlight apparatus is provided with a light source, such as a light emitting diode, and a light guiding plate or a diffusion plate for diffusing light from the light source. When a distance between the light source and the light guiding plate or the diffusion plate is not correctly uniform, or when the light emitted by the light emitting diode has a directivity, luminance irregularity or color irregularity may occur. In order to reduce such luminance irregularity, for example, Patent Document 4 listed below discloses a luminance control method and a display device in which correction values which are determined to make the luminance of a display panel substantially uniform are stored beforehand in a memory unit, a correction value corresponding to a position at which the display data is displayed is read from the memory unit, and the gain of the display data is corrected to make the luminance of the display panel substantially uniform.

### Patent Document 1: Japanese Laid-Open Patent Publication No. 7-191311

### Patent Document 2: Japanese Laid-Open Patent Publication No. 9-50031

### Patent Document 3: Japanese Laid-Open Patent Publication No. 2006-133708

### Patent Document 4: Japanese Laid-Open Patent Publication No. 2007-65572

### DISCLOSURE OF THE INVENTION

### Problem to be Solved by the Invention

However, the screening of light emitting diodes as in the Patent Document 3 above is complicated and increases the cost. It is difficult for the method of the Patent Document 3 to effectively reduce luminance irregularity which may be produced when the backlight apparatus is used along with the light guiding plate or the diffusion plate. In the case of the Patent Document 4 above, the correction of luminance irregularity is allowed only for an edge-type backlight. When an underneath type backlight is used, it is difficult to obtain the correction values by computation. There is little expectation that luminance irregularity occurs systematically when a surface light source, such as an organic or inorganic EL, is used, and it is impossible to obtain the correction values by computation in such a case.

Accordingly, it is an object of the present disclosure to provide an image display device, including a liquid crystal display device, which is able to easily correct luminance irregularity and color irregularity on a display surface of a display panel, including a liquid crystal panel, when a point light source, such as a light emitting diode, or a surface light source, such as an organic or inorganic EL, is used as a light source of a backlight.

### Means to Solve the Problem

In an embodiment which solves or reduces one or more of the above-mentioned problems, the present disclosure provides an image display device which displays an input video signal on a display panel, the image display device including: a computation unit to compute the reciprocal of a luminance signal and/or a chrominance signal, acquired when a white signal in the order of 100% is input to display a white screen on the display panel and an image of the white screen is captured by an imaging device; a memory unit to store the reciprocal computed by the computation unit as correction data; and a correction unit to correct luminance irregularity and/or color irregularity on the display panel by multiplication of the input video signal and the correction data stored in the memory unit.

Accordingly, it is possible to correct luminance irregularity and/or color irregularity which may take place due to various factors, regardless of the factors, and it is possible to display an image with good quality. Namely, according to the present disclosure, a white signal, e.g., a white signal of 100 IRE (white 100%), is input to display a white screen on the display panel, and an image of the displayed white screen is captured by an imaging device. Luminance irregularity and/or color irregularity of the white screen occurring on a display surface of the liquid crystal panel can be detected from a level difference in luminance and/or color of an output video signal. The luminance irregularity and/or the color irregularity on the display panel can be corrected to obtain uniform luminance and/or color, by multiplication of the input video signal and the reciprocal of the luminance signal and/or the chrominance signal acquired when the image of the white screen is captured.

In a second aspect of the present disclosure, the above-mentioned image display device may be arranged to further include an image format conversion unit to convert, when an image format of the luminance signal or the chrominance signal acquired from the imaging device differs from an image format of the input video signal, the image format of the luminance signal or the chrominance signal into the image format of the input video signal.

Accordingly, even when an image format of the input video signal and an image format of the imaging device differ from each other, it is possible to appropriately perform the correction of the video signal.

In a third aspect of the present disclosure, the above-mentioned image display device may be arranged to further include an area division unit to divide, into signal elements indicating areas of the white screen, the luminance signal or the chrominance signal acquired from the imaging device when capturing the image of the white screen, wherein the computation unit is arranged to compute an average of the signal elements of the luminance signal or the chrominance signal from the area division unit and compute the reciprocal of the average as being the correction data.

Accordingly, even when an image format of the input video signal and an image format of the imaging device differ from each other, it is possible to appropriately perform the correction of luminance or chromaticity, and it is possible to reduce the load of data processing of correction data.

In a fourth aspect of the present disclosure, the above-mentioned image display device may be arranged to further include a gamma correction unit to correct a nonlinear gamma characteristic of the display panel.

Accordingly, even if a gamma characteristic of the display panel is a non-linear characteristic, the correction of luminance or chromaticity can be appropriately performed through the gamma correction.

In a fifth aspect of the present disclosure, the above-mentioned image display device may be arranged so that the display panel is a liquid crystal panel or an organic EL panel.

Accordingly, not only in the non-spontaneous light emission type liquid crystal panel requiring the backlight, but also in the spontaneous light emission type organic EL panel, the correction of luminance or chromaticity can be performed, and the image correction in various types of display panels can be performed.

### EFFECT OF THE INVENTION

According to the present disclosure, luminance irregularity or color irregularity in any of various types of the display panels can be easily corrected. Especially, in a liquid crystal display having a backlight, an image on the display surface of the liquid crystal panel is captured by the imaging device regardless of the kind of the backlight, and luminance irregularity or color irregularity can be easily detected and corrected. Even if the backlight itself has luminance irregularity or color irregularity in some degree, luminance irregularity or color irregularity of the whole liquid crystal display can be easily corrected, and it is possible to reduce the cost considerably. The present disclosure is useful for the practical applications to large-sized liquid crystal television systems and monitors.

### BRIEF DESCRIPTION OF THE DRAWINGS

FIG. 1 is a diagram for explaining an example of a backlight according to the present disclosure in which a white light emitting diode is used as a light source of the backlight.

FIG. 2 is a diagram for explaining luminance irregularity when a white light emitting diode is used as a light source of a backlight according to the present disclosure.

FIG. 3 is a block diagram for explaining a method of correcting luminance irregularity according to the present disclosure.

FIG. 4 is a diagram for explaining luminance irregularity on a liquid crystal panel surface.

FIG. 5 is a diagram for explaining luminance irregularity of an image signal of an imaging device when an image of a liquid crystal panel surface is captured.

FIG. 6 is a block diagram for explaining a method of correcting luminance irregularity according to the present disclosure.

FIG. 7 is a block diagram for explaining a method of correcting luminance irregularity according to the present disclosure.

FIG. 8 is a diagram illustrating an example of areas of one screen which are indicated by signal elements into which an image signal of one screen from an imaging device is divided.

FIG. 9A is a diagram illustrating the arrangement in which color light emitting diodes 15 are arranged in one row.

FIG. 9B is a diagram illustrating the arrangement in which color light emitting diodes 15 are arranged in a triangular formation.

FIG. 10 is a diagram for explaining a method of correcting color irregularity according to the present disclosure when color light emitting diodes are used.

FIG. 11A is a diagram illustrating the arrangement in which color light emitting diodes 15 are arranged in one row.

FIG. 11B is a diagram illustrating the arrangement in which color light emitting diodes 15 are arranged in a rectangular formation.

FIG. 12A is a diagram illustrating the arrangement in which a white light emitting diode 11 and color light emitting diodes 15 are arranged in one row.

FIG. 12B is a diagram illustrating the arrangement in which a white light emitting diode 11 and color light emitting diodes 15 are arranged in a rectangular formation.

FIG. 13 is a block diagram illustrating the composition of a liquid crystal display device 300d of a fifth embodiment of the present disclosure.

FIG. 14 is a diagram for explaining a non-linear gamma characteristic of a liquid crystal panel.

FIG. 15 is a block diagram illustrating the composition of a liquid crystal display device 300e of a sixth embodiment of the present disclosure.

### DESCRIPTION OF THE REFERENCE NUMERALS

10 backlight using a light emitting diode as a light source
11 white light emitting diode
12 red light emitting diode
13 green light emitting diode
14 blue light emitting diode
15 color light emitting diode
16 light emitting diode
20, 307 liquid crystal panel
21 luminance irregularity in horizontal direction
211 portion with high luminance in horizontal direction
212 portion with low luminance in horizontal direction
22 luminance irregularity in vertical direction
221 portion with high luminance in vertical direction
222 portion with low luminance in vertical direction
300, 300a-300e liquid crystal display device
301 video signal processing unit
302 correction unit (multiplication unit)
303 I/F (e.g. LVDS)
304 memory unit
305 computation unit
306 backlight control unit
308 backlight
310 imaging device
311 scaler (image format conversion unit)
312 area division unit
313 gamma correction unit
314 look-up table
800 screen, an image of which is captured by an imaging device
801 areas of one screen indicated by signal elements into which an image signal of one screen from an imaging device is divided
1001 gamma characteristic of liquid crystal panel
1002 inverse gamma characteristic of liquid crystal panel

### BEST MODE FOR CARRYING OUT THE INVENTION

A description will be given of embodiments of the present disclosure with reference to the accompanying drawings.

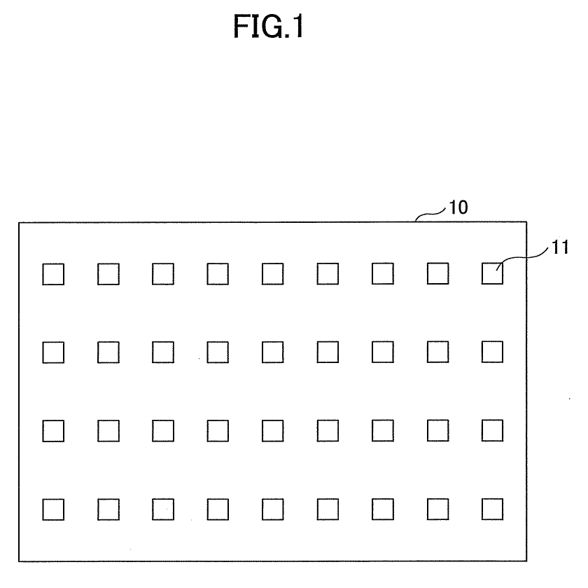

As an embodiment of the present disclosure, a backlight in which a white light emitting diode is used as a light source will be described. FIG. 1 illustrates an example of a backlight 10 according to the present disclosure in which white light emitting diodes 11 are arranged over the whole surface of the backlight 10 at almost equal intervals in a horizontal direction and in a vertical direction respectively. The interval between two adjacent ones of the white light emitting diodes 11 arranged in the horizontal direction is smaller than the interval between two adjacent ones of the white light emitting diodes 11 arranged in the vertical direction.

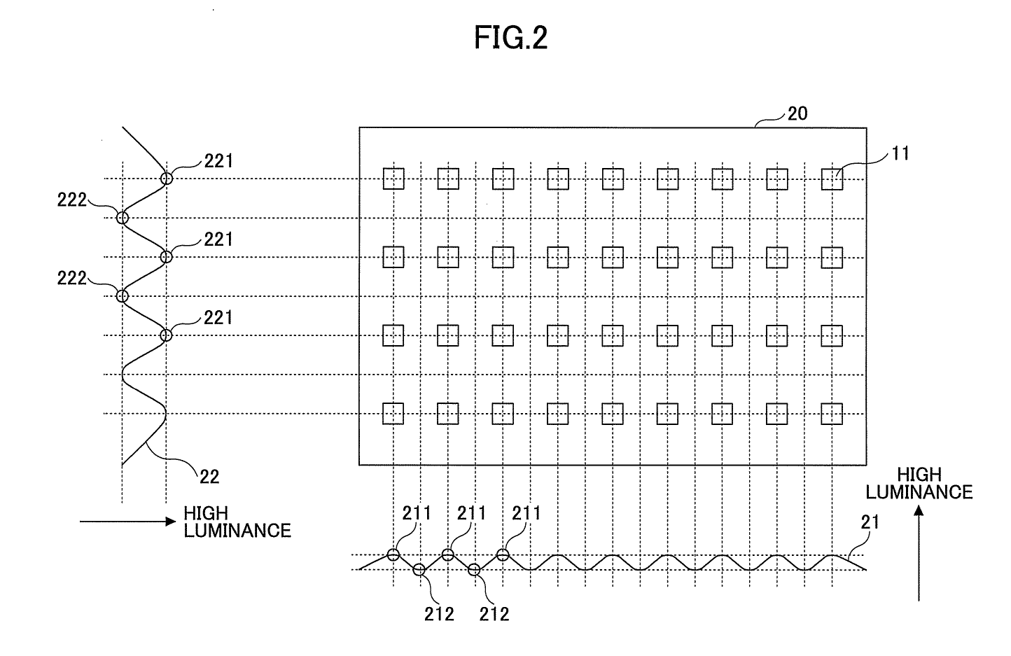

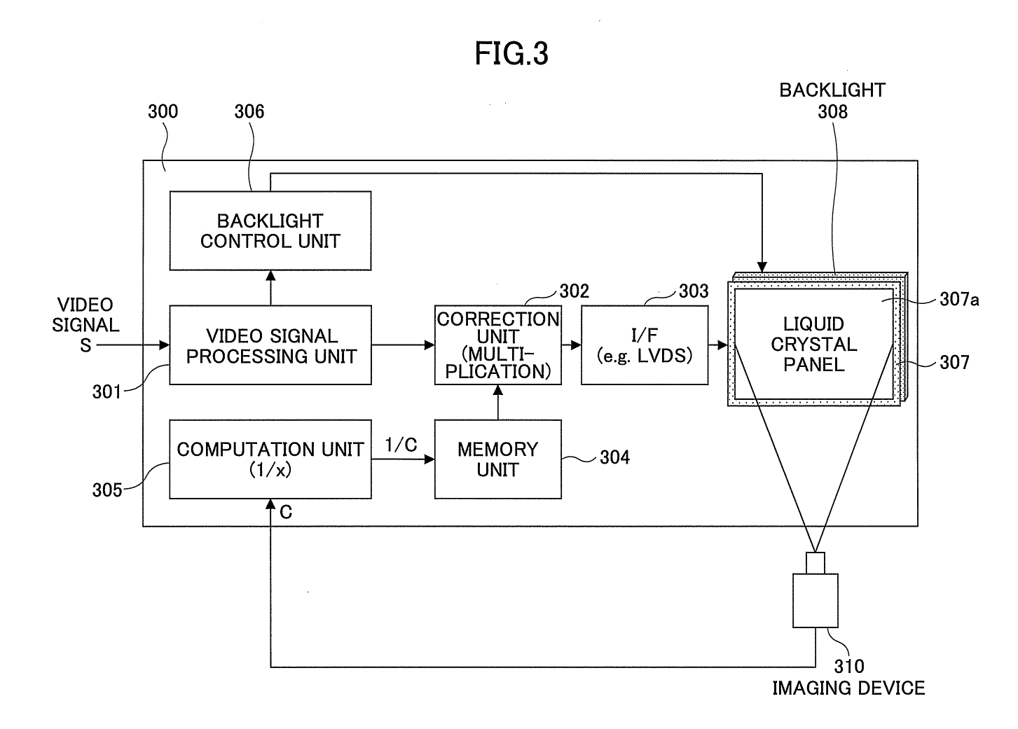

FIG. 2 illustrates an example of a luminance distribution when a backlight 10 is arranged on a back surface of a liquid crystal panel 20 and a white signal of the maximum luminance is input to the liquid crystal panel 20. In FIG. 2, the positions of the light emitting diodes 11 on the backlight 10 are superimposed on the illustration of the liquid crystal panel 20. In a liquid crystal display device (refer to FIG. 3) having the backlight 10 as illustrated in FIG. 1, when a white signal of 100 IRE (white 100%) which indicates the maximum luminance according to the NTSC standard is input to the liquid crystal display device and the backlight 10 is turned on, the luminance of the positions (211 and 221) near the light emitting diodes 11 on the liquid crystal panel 20 is high, the luminance of the positions (212 and 222) distant from the light emitting diodes 11 is low, and a luminance distribution is produced as illustrated in FIG. 2. For the sake of convenience, it is assumed that the light emitting diodes 11 have no variations in luminance and directivity. In this example, the intensity level in the horizontal direction changes as indicated by the curve 21 in FIG. 2 and the intensity level in the vertical direction changes as indicated by the curve 22 in FIG. 2. It can be understood that, in this example, luminance irregularity of the liquid crystal panel 20 occurs according to the arrangement of the light emitting diodes 11 in the backlight 10 on the back surface of the liquid crystal panel 20.

FIG. 3 is a block diagram illustrating the composition of a liquid crystal display device 300 in which a white light emitting diode 11 of a first embodiment of the present disclosure is used as a light source of the backlight. As illustrated in FIG. 3, the liquid crystal display device 300 of the first embodiment includes a video signal processing unit 301, a correction unit 302, an I/F (interface) unit 303, a liquid crystal panel 307, a backlight 308, a backlight control unit 306, an imaging device 310, a computation unit 305, and a memory unit 304. The liquid crystal panel 307 has a display surface 307a on which an image is displayed.

The video signal processing unit 301 is a circuit which performs signal processing of an input video signal S which is required for displaying an image on the liquid crystal panel 307. In the liquid crystal display device 300 of FIG. 3, a video signal S is input to the video signal processing unit 301 and the video signal processing unit 301 performs the signal processing required for the liquid crystal display device, such as image enhancement, noise reduction, gamma correction, black correction, and format conversion, which are not illustrated. The video signal after the signal processing is performed is output to the interface unit 303 through the correction unit 302 which will be described later. The interface unit 303 converts the video signal into a LVDS (low voltage differential signaling) signal, etc., and outputs the signal to the liquid crystal panel 307 connected to the interface unit 303.

The backlight control unit 306 is provided to control the backlight 308. For example, the backlight control unit 306 may be arranged to control luminance, chromaticity, etc. of the video signal output from the video signal processing unit 301.

The imaging device 310 is provided to capture an image indicated by a white signal of 100 IRE displayed on the display surface 307a of the liquid crystal panel 307. An image signal C output from the imaging device 310 may contain luminance irregularity, chromaticity irregularity, etc. Examples of the imaging device 310 include various cameras, such as a CCD (charge coupled device) camera, and a CMOS (complementary metal oxide semiconductor) camera. Any kind or form of camera may be used as the imaging device 310.

The computation unit 305 is provided to detect luminance irregularity or chromaticity irregularity in the image signal C from the imaging device 301 and compute correction data for correcting the luminance irregularity or chromaticity irregularity. Specifically, the computation unit 305 computes the reciprocal (1/C) of the image signal C and uses the reciprocal (1/C) as the correction data.

The memory unit 304 is a memory device to store the correction data computed by the computation unit 305, and any of memory devices of various forms may be used as the memory unit 304.

Next, the method of correcting luminance irregularity in the above-described liquid crystal display device 300 will be described. In the liquid crystal display device 300 of FIG. 3, when an image of the white signal of 100 IRE displayed on the liquid crystal panel 307 is captured by the imaging device 310 in the state in which luminance correction is not performed by the correction unit 302, the image signal output from the imaging device 310 has the waveform containing a pulsating signal component as indicated by the curve 21 or the curve 22 in FIG. 2. The image signal (digital signal) C from the imaging device 310 is sent to the computation unit 305 and the computation unit 305 computes the reciprocal 1/C of the digital video signal S, so that the reciprocal 1/C is stored in the memory unit 304 as correction data containing luminance irregularity information.

On the other hand, the video signal S from the video signal processing unit 301 is output to the correction unit (multiplication unit) 302. The correction unit 302 multiplies the video signal S by the correction data (1/C) read from the memory unit 304. Hence, the luminance irregularity can be corrected by raising the level of a video signal portion corresponding to a dark portion of the image signal with an excessively low level and lowering the level of a video signal portion corresponding to a bright portion of the image signal with an excessively high level.

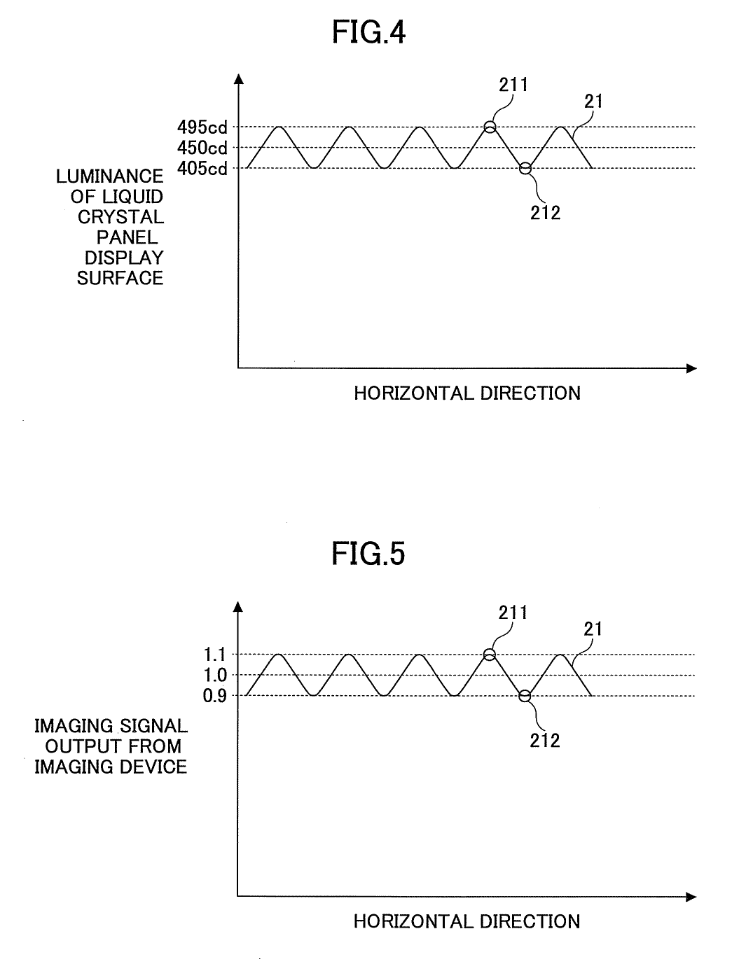

Next, a description will be given of the method of correcting luminance irregularity according to the present disclosure with reference to FIG. 4. FIG. 4 illustrates an example of a horizontal-direction luminance distribution on the display surface 307a of the liquid crystal panel 307. Specifically, in the luminance distribution of FIG. 4, the horizontal-direction luminance irregularity 21 as illustrated in FIG. 2 has ±10% of a setting luminance 450 cd/m2. The luminance of a dark portion 212 is 405 cd/m2 (−10%) lower than the setting luminance 450 cd/m2, and the luminance of a bright portion 211 is 495 cd/m2 (+10%) higher than the setting luminance 450 cd/m2.

FIG. 5 illustrates an example of luminance irregularity which is expressed by the ratio of an image signal luminance level to a reference level, the luminance level indicating the luminance of an image signal acquired when an image having the luminance distribution of FIG. 4 on the display surface 307a of the liquid crystal panel 307 is captured by the imaging device 310. The adjustment of the imaging device 310 is made by the aperture, the electronic shutter speed, etc. to match the signal portion corresponding to the setting luminance 450 cd/m2 with 1.0 (100 IRE) as illustrated in FIG. 5. At this time, the luminance ratio of the image signal C output from the imaging device 310 is increased at the bright portion 211 which is 495 cd/m2 (10%) to 1.1 (110 IRE) by 10%, while the luminance ratio of the image signal. C is decreased at the dark portion 212 to 0.9 (90 IRE) by 10%. It is necessary to set up the imaging device 310 by canceling the gamma correction (gamma=1), so that the imaging device 301 may not be saturated even when capturing the bright portion (in this example, 495 cd/m2) of the image on the display surface 307a.

In the above example, the setting luminance is 450 cd/m2, the luminance of the bright portion 211 is 495 cd/m2, and the luminance ratio is set to 495/450=1.1. The image signal C containing luminance irregularity output from the imaging device 310 is as illustrated in FIG. 5. The amplitude of the image signal at the portion corresponding to the setting luminance 450 cd/m2 is set to 1.0 (100 IRE). The amplitude of the image signal at the bright portion 211 (in this example, the luminance is 495 cd/m2) is set to 1.1 (110 IRE). The amplitude of the image signal at the dark portion 212 (in this example, the luminance is 405 cd/m2) is set to 405/450=0.9.

Subsequently, the image signal C acquired when the image on the liquid crystal panel display surface 307a is captured by the imaging device 310 is sent to the computation unit 305. The computation unit 305 computes the reciprocal 1/C of the image signal C, and the reciprocal 1/C is stored in the memory unit 304 as the correction data. On the other hand, the video signal S input to the liquid crystal display device 300 is processed by the video signal processing unit 301 and the processed video signal is output to the correction unit 302. The correction unit 302 multiplies a portion of the video signal S by a corresponding portion of the correction data (1/C) read from the memory unit 304. Hence, the luminance irregularity can be corrected.

Generally, there are various kinds of image format (or signal format) of an input video signal S: VGA (640×480 pixels), XGA (1024×768 pixels), SXGA (1240×1024 pixels), etc. for personal computers; and 480i (480: the number of effective scanning lines, i: interlacing), 720p (p: progressive), 1080i, etc. for televisions. It is preferred that the imaging device 310 is capable of dealing with all the input image formats.

For example, if the image format of the input video signal S is VGA (640×480 pixels) and the image format of the image signal from the imaging device 310 is VGA (640×480 pixels), there is a one-to-one correspondence between the pixels of the input video signal S and the pixels of the image signal C from the imaging device. In this case, the luminance irregularity can be corrected with no problem.

Next, a case in which an image format of the video signal S input to the liquid crystal display device 300 and an image format of the image signal C from the imaging device 310 differ from each other will be described.

For example, when the image format of the video signal S input to the liquid crystal display device 300 is the XGA format (1024×768 pixels) and the image format of the imaging device 310 is the VGA format (640×480 pixels), the number of pixels of one screen differs and there is no one-to-one correspondence between the pixels of the input video signal S and the pixels of the image signal C from the imaging device 310. The luminance correction according to the present disclosure is carried out by controlling the level of each of the pixels of the video signal S input to the liquid crystal display device 300 in accordance with the level of each of the pixels of the image signal C acquired to contain luminance irregularity. Hence, it is necessary to bring the pixels of the image signal C of the imaging device into correspondence with the pixels of the input video signal S.

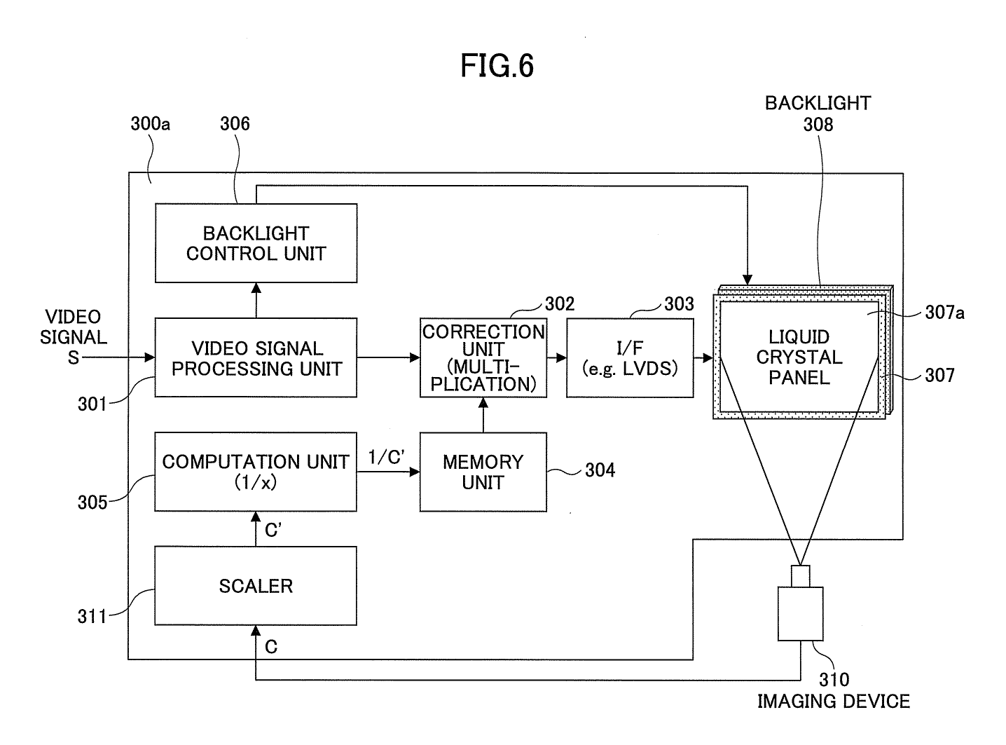

One method for solving the problem is to match the image format of the image signal C from the imaging device 310 with the image format of the video signal S input to the liquid crystal display device 300. FIG. 6 illustrates the composition of a liquid crystal display device 300a of a second embodiment of the present disclosure which is capable of converting an image format of an image signal. The liquid crystal display device 300a of the second embodiment of FIG. 6 differs from the liquid crystal display device 300 of the first embodiment of FIG. 3 in that a scaler 311 which is an image format conversion unit is provided. In FIG. 6, the elements which are the same as corresponding elements of the liquid crystal display device 300 of FIG. 3 are designated by the same reference numerals, and a description thereof will be omitted.

As illustrated in FIG. 6, for example, when the image format of the input video signal S is XGA (1024×768 pixels) and the image format of the image signal C of the imaging device 310 is VGA (640×480 pixels), the scaler 311 converts the image format of the image signal C (XGA) of the imaging device 310 into the image format (VGA) which is the same as that of the input video signal S, and outputs the image signal C′ of the image format (VGA) to the computation unit 305. The computation unit 305 computes the reciprocal of the image signal C′. The reciprocal of the image signal C′ is stored in the memory unit 304 as the correction data. Similarly, when the image format of the input video signal S is 1080i, the scaler 311 converts the image format of the image signal C of the imaging device 310 into the image format (1080i), and outputs the image signal C′ of the image format (1080i) to the computation unit 305. The computation unit 305 computes the reciprocal 1/C′ of the image signal C′. The reciprocal 1/C′ is stored in the memory unit 304 as the correction data.

The scaler 311 in this embodiment is an image format (resolution) conversion unit which has a scaling function of expanding or reducing an original image in size so as to suit for the display screen size, when displaying the original image of a first resolution different from a second resolution of the liquid crystal panel 307. Any of various types of the scaler 311 may be used in the liquid crystal display device 300a of the second embodiment.

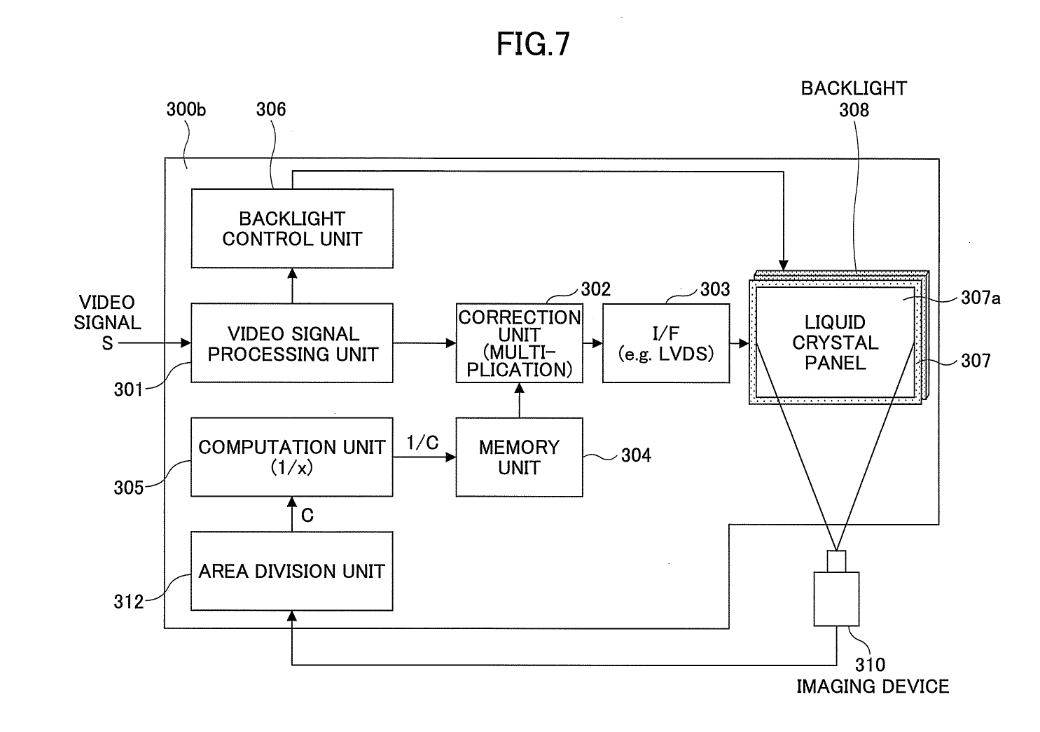

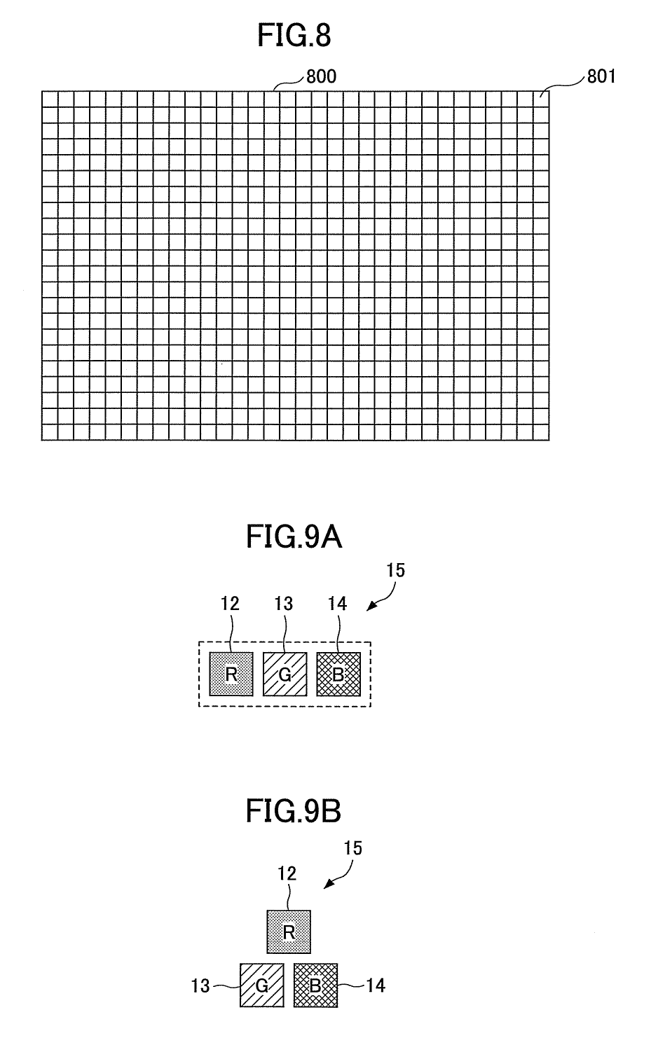

Next, another case in which an image format of the video signal S input to the liquid crystal display device 300 and an image format of the image signal C from the imaging device 310 differ from each other will be described with reference to FIG. 7 and FIG. 8.

FIG. 7 illustrates the composition of a liquid crystal display device 300b of a third embodiment of the present disclosure which is capable of performing the image format conversion different from that in the embodiment of FIG. 6. The liquid crystal display device 300b of the third embodiment of FIG. 7 differs from the liquid crystal display device 300a of the second embodiment of FIG. 6 in that an area division unit 312 is provided instead of the scaler 311. Generally, luminance irregularity occurring in the backlight 308 is not a rapid luminance change but a loose luminance change with respect to the number of pixels of the input video signal S. In other words, it may be satisfactory that the image signal C containing luminance irregularity, acquired from the imaging device 310, has a comparatively low resolution. Therefore, it is not necessary to perform the signal processing of the image signal C from the imaging device 310 on a pixel basis. The area division unit 312 is provided to divide the image signal (luminance signal) C from the imaging device 310 into signal elements indicating areas of one screen, each area having a size larger than a pixel size. In this case, the computation unit 305 is provided to compute an average of the signal elements of the image signal (luminance signal) C from the area division unit 312 and compute the reciprocal (1/C) of the average as the correction data. This allows the processing load of the computation unit 305 to be reduced.

FIG. 8 illustrates an example of areas of one screen which are indicated by signal elements into which an image signal C of one screen is divided. Unlike the XGA (1024×768 pixels) or the VGA (640×480 pixels) described above, one screen is divided into a plurality of areas each with a comparatively large size in the example of FIG. 8. As illustrated in FIG. 8, the area division of an image signal C with luminance irregularity can be carried out, and the level of the video signal S input to the liquid crystal display device 300b can be controlled for each of the plurality of areas.

The number of areas into which the image signal of one screen is to be divided by the area division varies with the type and structure of the backlight 308. For example, in the underneath type in which light emitting diodes 11 are arranged directly underneath the liquid crystal panel 307, fine luminance irregularities are likely to occur when compared with the case of the edge type backlight device. In the case of the underneath type, it is necessary to make the area division fine. Specifically, when 1500 light emitting diodes 11 are uniformly arranged in 50 rows (horizontal) and 30 columns (vertical), the number of areas that is adequate for practical applications is as follows: the number of areas in the horizontal direction is in a range of 200-250; and the number of areas in the vertical direction is in a range of 120-150. But this depends on the structure and arrangement of the light emitting diodes 11. The area division unit 312 is provided to carry out the area division described above.

In the foregoing embodiments, the liquid crystal display devices 300, 300a, and 300b in which the white light emitting diodes 11 are used in the backlight 308 have been described. Alternatively, color light emitting diodes may be used instead. When R (red), G (green) B (blue) light emitting diodes are used as the color light emitting diodes, not only luminance irregularity but also color irregularity can be corrected.

FIG. 9A and FIG. 9B illustrate examples of arrangement in which a red light emitting diode 12, a green light emitting diode 13, and a blue light-emitting diode 14 are used as color light emitting diodes 15. FIG. 9A illustrates an example of the arrangement of color light emitting diodes 15 in which a red light emitting diode 12, a green light emitting diode 13, and a blue light-emitting diode 14 are arranged side by side in one row. FIG. 9B illustrates an example of the arrangement of color light emitting diodes 15 in which a red light emitting diode 12, a green light emitting diode 13, and a blue light-emitting diode 14 are arranged in a triangular formation. As illustrated in FIG. 9A and FIG. 9B, one unit of the color light emitting diodes 15, including the red light emitting diode 12, the green light emitting diode 13, and the blue light-emitting diode 14, may be used instead of one unit of the white light emitting diodes 11. The method of correction is essentially the same as that of the case in which the white light emitting diodes 11 are used. Namely, it is assumed that color irregularity occurs when the white signal of 100 IRE is input to one of the liquid crystal display devices 300, 300a and 300b to display the white signal of 100 IRE on the display surface 307a of the liquid crystal panel 307. In such a case, a pulsating signal component (color irregularity) similar to the luminance irregularity as illustrated in FIG. 4 arises in any of the image signals R, G and B which are acquired when an image of the white screen on the display surface 307a is captured by the imaging device 310 (color imaging device). For example, if a certain portion of the screen is reddish, a corresponding portion of the R signal (red signal) for the screen portion has a level larger than the level of other portions.

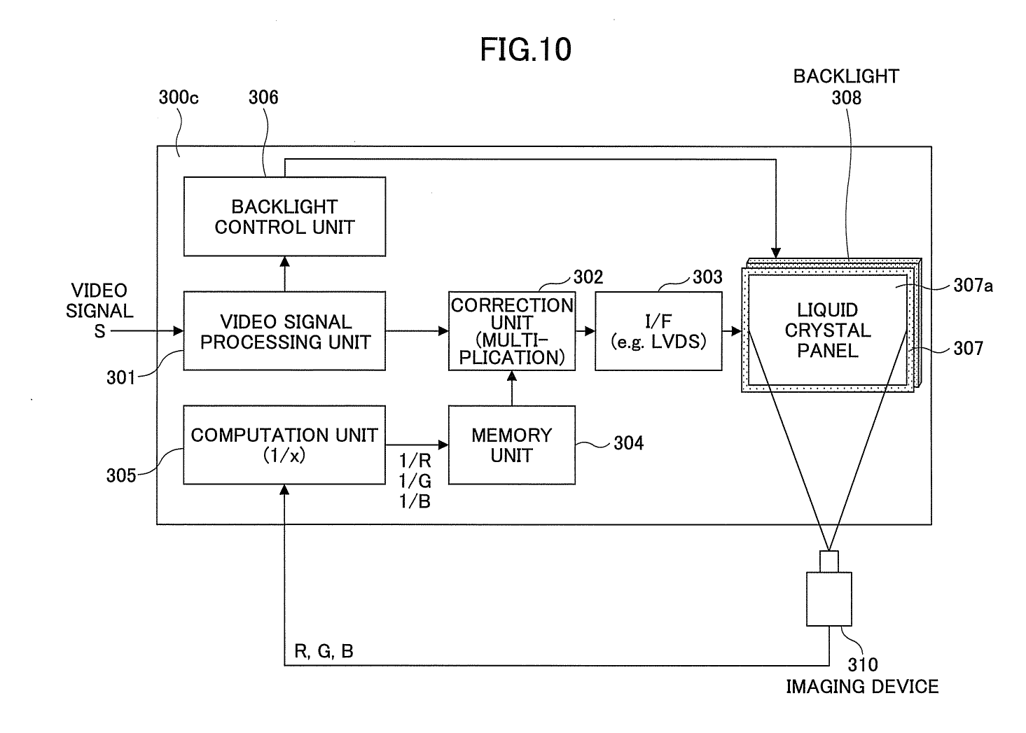

FIG. 10 illustrates the composition of a liquid crystal display device 300c of a fourth embodiment of the present disclosure in which a backlight 308 including color light emitting diodes 15 is used. As illustrated in FIG. 10, the computation unit 305 is provided to compute the reciprocals (1/R, 1/G, 1/B) of the R, G, and B signals from the imaging device 310, and the memory unit 304 is provided to store the reciprocals (1/R, 1/G, 1/B) from the computation unit 305. On the other hand, the video signal from the video signal processing unit 301 is input to the correction unit 302, and the correction unit (multiplication unit) 302 performs the multiplication of the video signal and the reciprocals 1/R, 1/G, 1/B read from the memory unit 304, so that color irregularity is corrected. Specifically, the color irregularity can be corrected by raising the level of a video signal portion corresponding to a portion of each chrominance signal with an excessively low level and lowering the level of a video signal portion corresponding to a portion of each chrominance signal with an excessively high level.

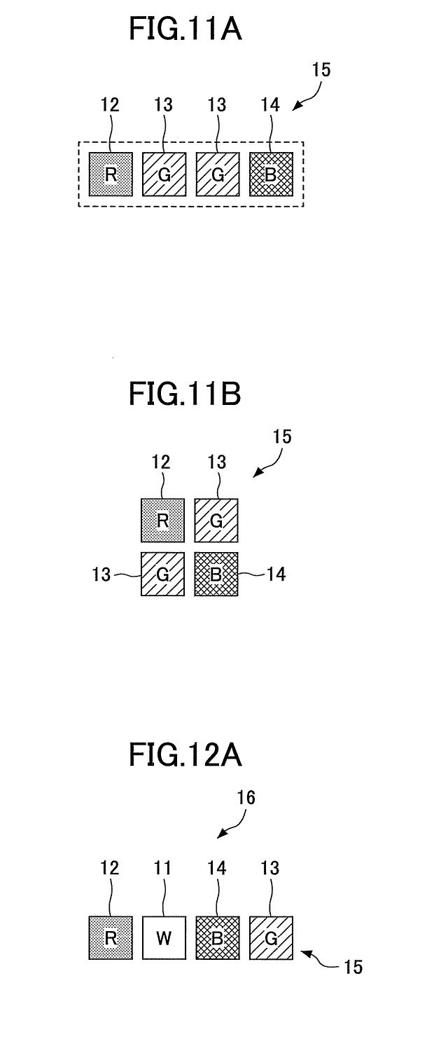

FIG. 11A and FIG. 11B illustrate examples of arrangement of color light emitting diodes 15 different from the arrangement of FIG. 9A and FIG. 9B. FIG. 11A illustrates an example of the arrangement in which a red light emitting diode 12, a blue light-emitting diode 14, and two green light emitting diodes 13 are arranged side by side in one row. FIG. 11B illustrates an example of the arrangement in which a red light emitting diode 12, a blue light-emitting diode 14, and two green light emitting diodes 13 are arranged in a grid-like rectangular formation. As illustrated, as long as the color light emitting diodes 15 can generate a white signal of 100 IRE, the color light emitting diodes 15 of respective colors may be arranged in arbitrary combination. Also in such a case, the liquid crystal display device 300c of the fourth embodiment of FIG. 10 is applicable in a similar manner.

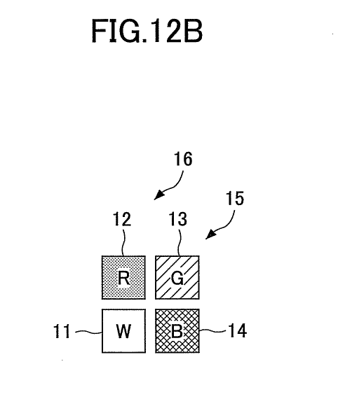

FIG. 12A and FIG. 12B illustrate examples of arrangement of a light emitting diode 16 which includes a white light emitting diode 11, a red light emitting diode 12, a green light emitting diode 13, and a blue light-emitting diode 14. In the following, when the color of light of red, blue and green light emitting diodes should be disregarded, the light emitting diodes will be referred to as color light emitting diodes 15.

FIG. 12A illustrates an example of the arrangement in which the white light emitting diode 11, the red light emitting diode 12, the green light emitting diode 13, and the blue light-emitting diode 14 are arranged side by side in one row. FIG. 12B illustrates an example of the arrangement in which the white light emitting diode 11, the red light emitting diode 12, the green light emitting diode 13, and the blue light-emitting diode 14 are arranged in a grid-like rectangular formation. As illustrated, the light emitting diode 16 of the backlight 308 may be arranged by combining the white light emitting diode 11 and the color light emitting diodes 15. With the composition of the light emitting diodes of the backlight 308, it is possible to correct both luminance irregularity and color irregularity.

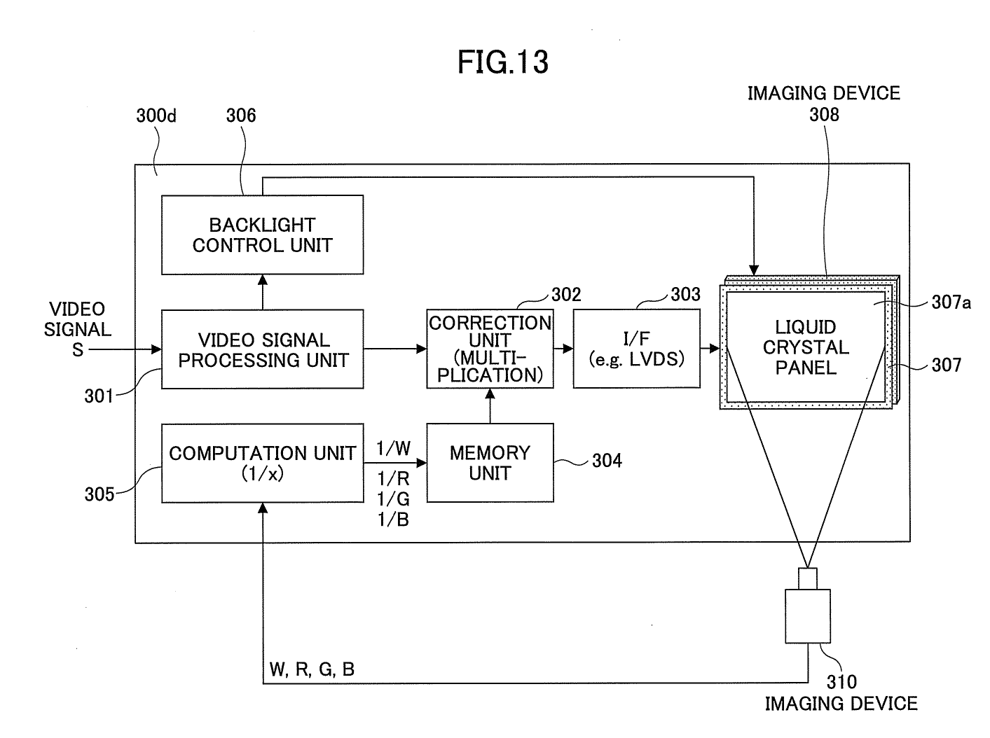

FIG. 13 illustrates the composition of a liquid crystal display device 300d of a fifth embodiment of the present disclosure in which a backlight 308 including the white light emitting diode 11 and the color light emitting diodes 15 arranged in combination as illustrated in FIG. 12A or FIG. 12B is used. As illustrated in FIG. 13, the composition of the liquid crystal display device 300d of the fifth embodiment is essentially the same as that of liquid crystal display device 300c of FIG. 10. The liquid crystal display device 300d of FIG. 13 differs from the liquid crystal display device 300c of FIG. 10 only in that the computation unit 305 further computes the reciprocal (1/W) of a luminance signal W generated by the white light emitting diode 11 as the correction data. It can be understood that this function of the liquid crystal display device 300d of FIG. 13 is the same as the function of computing the reciprocal 1/C of the image signal C as in the embodiment of FIG. 3, in order to correct luminance irregularity. The computation unit 305 of this embodiment computes both the correction data for correcting color irregularity and the correction data for correcting luminance irregularity. This allows the correction unit 302 to correct both luminance irregularity and color irregularity. Because the method of computation of the reciprocal is the same as in the foregoing embodiments, the computation unit 305 as in the foregoing embodiments may be used for this embodiment and modified to enable the computation of four correction data items.

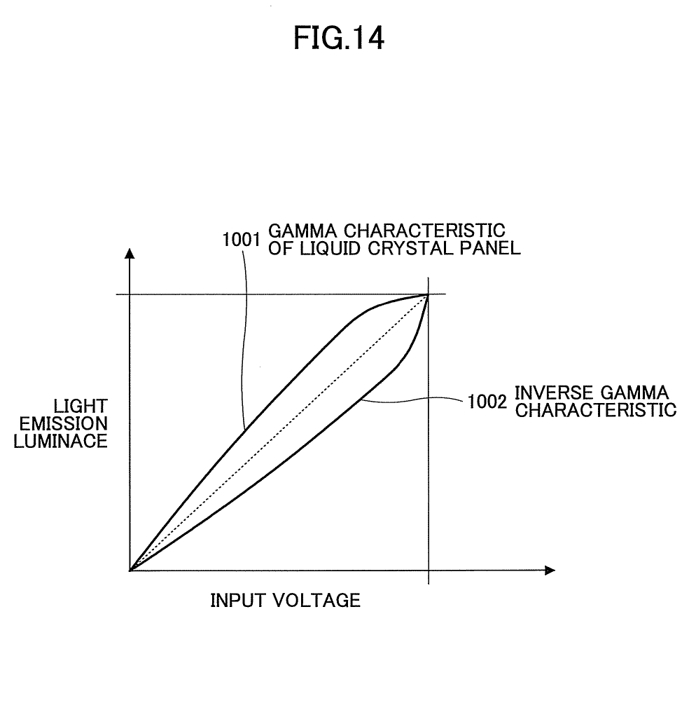

Next, an example in which the image display device of the sixth embodiment is applied to a display panel having a nonlinear gamma characteristic will be described. Generally, the characteristic (gamma characteristic) of the input voltage vs. light emission luminance of a liquid crystal panel 307 or an organic EL panel may be non-linear and the gradient may not show gamma=1 as indicated by the curve 1001 in FIG. 14. In the non-linear case, if the white signal of white 100% is input, luminance irregularity may be corrected by the reciprocal of the image signal from the imaging device 300 as described above. However, if the level of the white signal changes, an error will arise because of the non-linear characteristic. To eliminate the error, it is necessary to correct the non-linear characteristics of the liquid crystal panel.

In order to correct the non-linear characteristic of the liquid crystal panel, the nonlinear correction is performed with an inverse characteristic (as indicated by the curve 1002 in FIG. 14) of the gamma characteristic of the liquid crystal panel. Specifically, the curve of an inverse characteristic is determined based on the gamma characteristic of the liquid crystal panel, data of the inverse characteristic curve is stored in a look-up table (not illustrated), and, at the time of performing the multiplication by the correction unit 302, the non-linear characteristic is corrected by multiplying the data read from the look-up table.

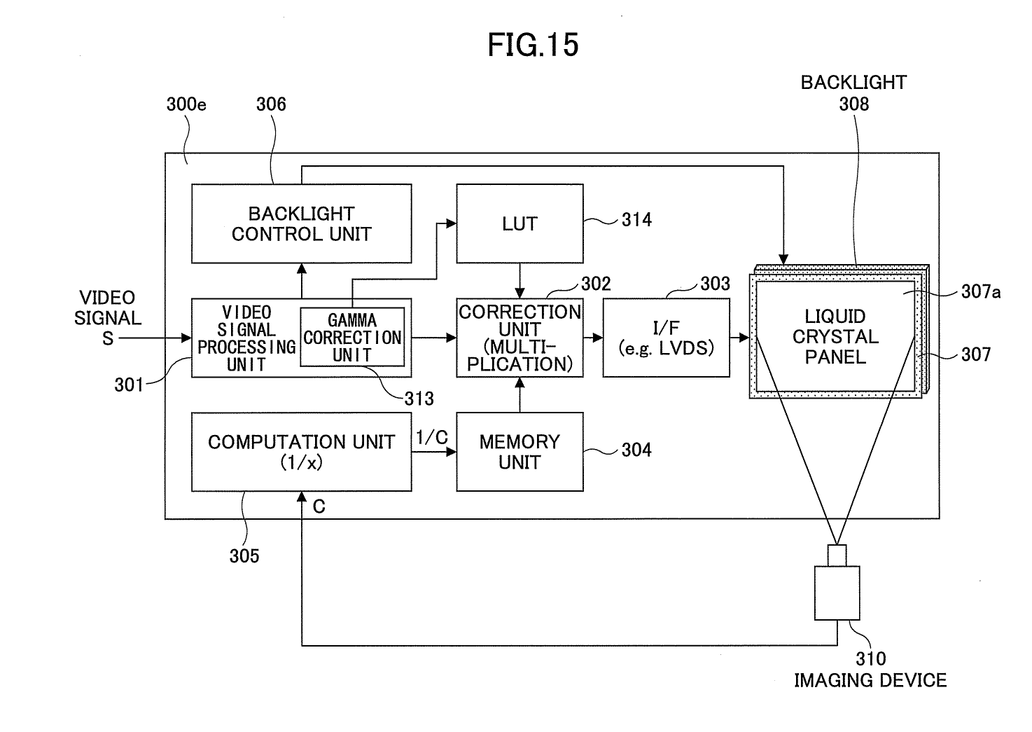

FIG. 15 illustrates the composition of a liquid crystal display device 300e of a sixth embodiment of the present disclosure which is capable of correcting a gamma characteristic. The liquid crystal display devices 300e of the sixth embodiment of FIG. 15 differs from the liquid crystal display device 300 of the first embodiment of FIG. 3 in that a gamma correction unit 313 and a look-up table (LUT) 314 are further included in the liquid crystal display device 300 of the first embodiment. In FIG. 15, the elements which are essentially the same as corresponding elements of the previously described first embodiment are designated by the same reference numerals, and a description thereof will be omitted.

In the embodiment of FIG. 15, the gamma correction unit 313 is provided to compute an inverse gamma characteristic 1002 based on the gamma characteristic 1001 of the liquid crystal panel 307, as described above with reference to FIG. 14.

The gamma correction unit 313 may be arranged to correct, after the inverse gamma characteristic 1002 is computed, the gamma characteristic to obtain a linear characteristic (gamma=1). However, in the embodiment of FIG. 15, the gamma correction unit 313 is provided to compute the inverse gamma characteristic 1002, and the correction unit 302 is provided to correct the gamma characteristic.

The look-up table 314 is a memory unit to store the inverse gamma characteristic computed by the gamma correction unit 313. At the time of correcting luminance irregularity, the correction unit 302 reads out the inverse gamma characteristic stored in the look-up table 314 and performs correction of the gamma characteristic by multiplication of the inverse gamma characteristic. Accordingly, even when the liquid crystal panel 307 has a non-linear gamma characteristic, the gamma characteristic can be corrected to a linear characteristic and correction of luminance irregularity can be performed appropriately.

For the sake of convenience, in the embodiment of FIG. 15, the gamma correction unit 313 and the look-up table 314 are arranged in the liquid crystal display device 300 of the first embodiment. Alternatively, the liquid crystal display of the sixth embodiment may be arranged similar to the liquid crystal display devices 300a-300d of the second to fifth embodiments. Namely, also in the case of the liquid crystal panel 307 having a nonlinear gamma characteristic, luminance irregularity or color irregularity can be appropriately corrected and the image format can be converted if needed, so that displaying of an image can be performed with good quality of image.

In the foregoing, the liquid crystal display devices 300 and 300a-300e in which the light emitting diode 16 is used as the backlight 308 thereof have been described. Alternatively, an organic EL or an inorganic EL may be used as the backlight 308. In recent years, the inorganic EL is being put in practical use as a surface light source. However, the inorganic EL used as the surface light source shows a considerable amount of luminance irregularity. In the case where an inorganic EL is used as the backlight 308 of the liquid crystal display devices 300 and 300a-300e requiring high image quality, correction of luminance irregularity must be carried out. In such a case, it is possible to correct luminance irregularity by the same method as described in the foregoing.

According to the present disclosure, it is also possible to correct color irregularity of an organic EL panel (not illustrated) which is of a spontaneous light emission type, by the same method. Although the case in which the liquid crystal panel 307 is used has been described in the foregoing first to sixth embodiments, it is also possible to use an organic EL panel as the display panel, and, in such a case, it is also possible to correct luminance irregularity or color irregularity. In the latter case, the backlight 308 is unnecessary, and so the image display device according to the present disclosure may be arranged by omitting the backlight 308 and the backlight control unit 306 and replacing the liquid crystal panel 307 with an organic EL panel.

The present disclosure is not limited to the above-described embodiments and variations and modifications may be made without departing from the scope of the present disclosure. For example, any of the foregoing first to sixth embodiments may be suitably combined with another to construct an image display device provided with composite functions and composite units.

### INDUSTRIAL APPLICABILITY

The present disclosure is applicable to image display devices having a display panel, such as a liquid crystal display panel, an organic EL panel, or an inorganic EL panel.

The present international application is based upon and claims foreign priority of Japanese patent application No. 2008-094475, filed on Apr. 1, 2008, and Japanese Patent Application No. 2009-006160, filed on Jan. 14, 2009, the contents of which are incorporated herein by reference in their entirety.

1. An image display device which displays an input video signal on a display panel, comprising:
a computation unit to compute the reciprocal of a luminance signal and/or a chrominance signal, acquired when a white signal in the order of 100% is input to display a white screen on the display panel and an image of the white screen is captured by an imaging device;
a memory unit to store the reciprocal computed by the computation unit as correction data; and
a correction unit to correct luminance irregularity and/or color irregularity on the display panel by multiplication of the input video signal and the correction data stored in the memory unit.

2. The image display device according to claim 1, further comprising an image format conversion unit to convert, when an image format of the luminance signal or the chrominance signal acquired from the imaging device differs from an image format of the input video signal, the image format of the luminance signal or the chrominance signal into the image format of the input video signal.

3. The image display device according to claim 1, further comprising an area division unit to divide, into signal elements indicating areas of the white screen, the luminance signal or the chrominance signal acquired from the imaging device when capturing the image of the white screen,
wherein the computation unit is arranged to compute an average of the signal elements of the luminance signal or the chrominance signal from the area division unit and compute the reciprocal of the average as being the correction data.

4. The image display device according to claim 1, further comprising a gamma correction unit to correct a nonlinear gamma characteristic of the display panel.

5. The image display device according to claim 1, wherein the display panel is a liquid crystal panel or an organic EL panel.
